(19) United States
(12) Patent Application Publication
(10) Pub. No.: US 2022/0349561 A1
(43) Pub. Date: Nov. 3, 2022

(54) LIGHTING ASSEMBLY INTEGRATED WITH A TRAVELING CASE

(71) Applicant: Bienali Promotions, LLC, Highland Park, IL (US)

(72) Inventor: Lauri Zessar, Highland Park, IL (US)

(73) Assignee: Bienali Promotions, LLC, Highland Park, IL (US)

(21) Appl. No.: 17/246,765

(22) Filed: May 3, 2021

(51) Int. Cl. F21V 21/22; F21V 23/04; F21S 9/02; A45C 5/03; A45C 15/06; A45C 5/14

(52) U.S. Cl. CPC F21V 21/22; F21V 23/04; F21S 9/02; A45C 5/03; A45C 15/06; A45C 5/14; F21Y 2105/18

(57) ABSTRACT

In one embodiment there is provided a portable lighting assembly that includes a travel case and a lighting assembly. The lighting assembly is mounted to a bottom of the travel case and includes a telescopic support rod. A lighting device is secured to the rod and has a lamp. The lighting device is configured to plug into a power supply. Thereby, when dissembled the portable lighting assembly is secured and stored within the travel case and is easily portable; and when assembled, the portable lighting assembly is configured to provide portable lighting when connected to a portable power supply.

### FIELD OF THE INVENTION

The current invention relates generally to a portable lighting assembly and more specifically, a lighting assembly integrated with a traveling case for professional stylists that require their own certain lighting when traveling to different customers.

### BACKGROUND OF THE INVENTION

Professional stylists, like hairdressers, colorists, makeup artists, fashion consultants, often work in salons or stores. In these types of salon or store settings the lighting is specifically tailored for the stylist. However, there is now a need for stylists to be more remote. The ability for a stylist to travel to customer's homes is greater as customer's are not as eager to go to public salons or stores. However, the lighting in a customer's home is not designed for the stylist's needs. As such, a great disservice can be made to a customer. There is thus a need for a stylist to be able to carry all of their equipment along with a portable lighting assembly that allows the stylist to set up the proper lighting in different customer's homes.

### SUMMARY OF THE INVENTION

There is provided in one embodiment of the invention a portable lighting assembly. The portable lighting assembly includes a travel case and a lighting assembly.

The travel case has a bottom section with a cavity defined within the travel case and has a base surface defined in the bottom section. The lighting assembly has a pedestal mounted to the bottom section of the travel case. A telescopic support rod is secured to the pedestal and is secure to a lighting device. The lighting device has a lamp holder in connection with a lamp and has a switch assembly wired to the lighting device to allow the lamp to illuminate when connected to a power supply and when activated. Whereby, when dissembled, the portable lighting assembly is secured and stored within the travel case and is easily portable; and when assembled, the portable lighting assembly provides portable lighting when connected to a power supply and when the switch assembly is activated. In addition, the telescopic support rod is configured to adjust the height of the lamp.

The portable lighting assembly in accordance with one or more embodiments of the invention may define the power supply as a portable rechargeable power supply configured to connect to the switch assembly. In addition, the portable lighting assembly may include a halo lamp.

The travel case in accordance with one or more embodiments may include a top section and a sealable fastener to permit the top section to open and close with respect to the bottom section. The travel case may also include wheels and may include a handle.

The lighting assembly may be secured to either the base surface of the travel case or may be secured to support ribs running along the length of the base surface.

Numerous other advantages and features of the invention will become readily apparent from the following detailed description of the invention and the embodiments thereof, from the claims, and from the accompanying drawings.

### BRIEF DESCRIPTION OF THE FIGURES

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 illustrates a traveling case used to transport and store a lighting assembly in accordance with one embodiment of the present invention;

FIG. 2 illustrates the traveling case in an open position in accordance with one embodiment of the present invention;

FIG. 3 illustrates the bottom of the traveling case and the pedestal of the lighting assembly in accordance with one embodiment of the present invention;

FIG. 4 illustrates the traveling case and the initial assembly of the lighting assembly in accordance with one embodiment of the present invention;

FIG. 5 is another illustration of the traveling case and the initial assembly of the lighting assembly in accordance with one embodiment of the present invention;

FIG. 6 is an illustration of the traveling case and assembled lighting assembly in accordance with one embodiment of the present invention;

FIG. 7 is an illustration of the traveling case and the lighting assembly with the telescoping rod in accordance with one embodiment of the present invention; and

FIG. 8 illustrates the invention with the lamp illuminating in accordance with one embodiment of the present invention.

### DETAILED DESCRIPTION OF THE INVENTION

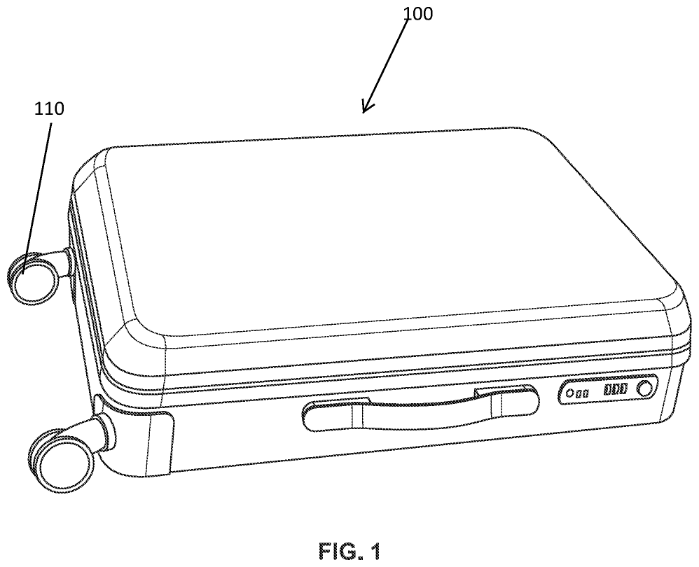

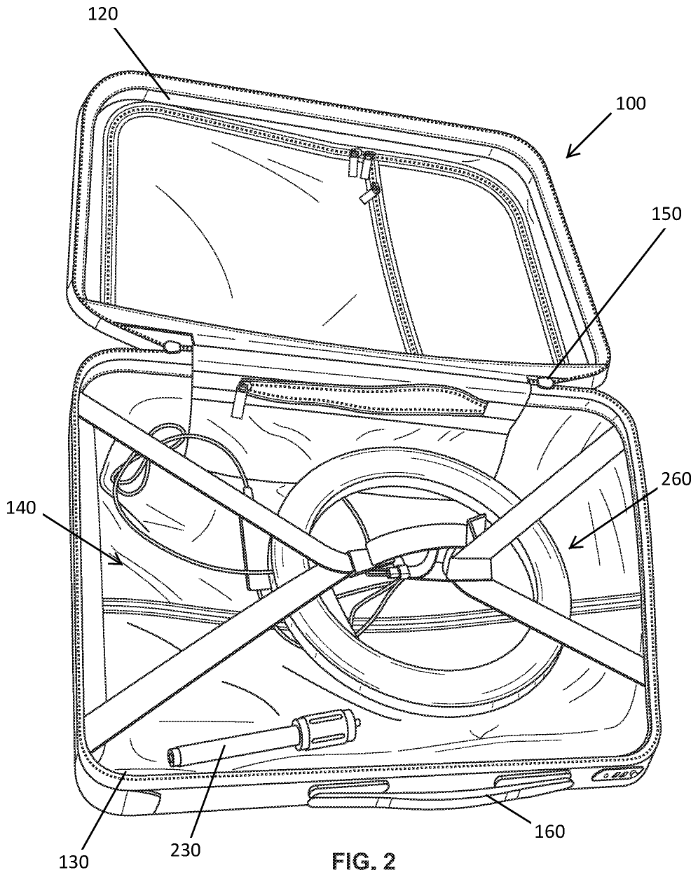

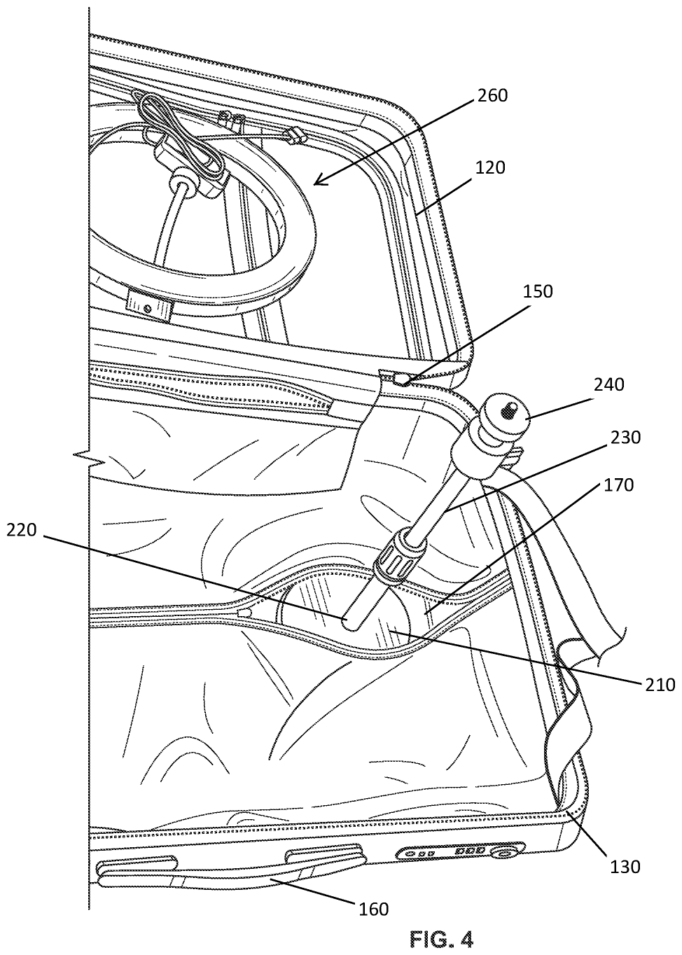

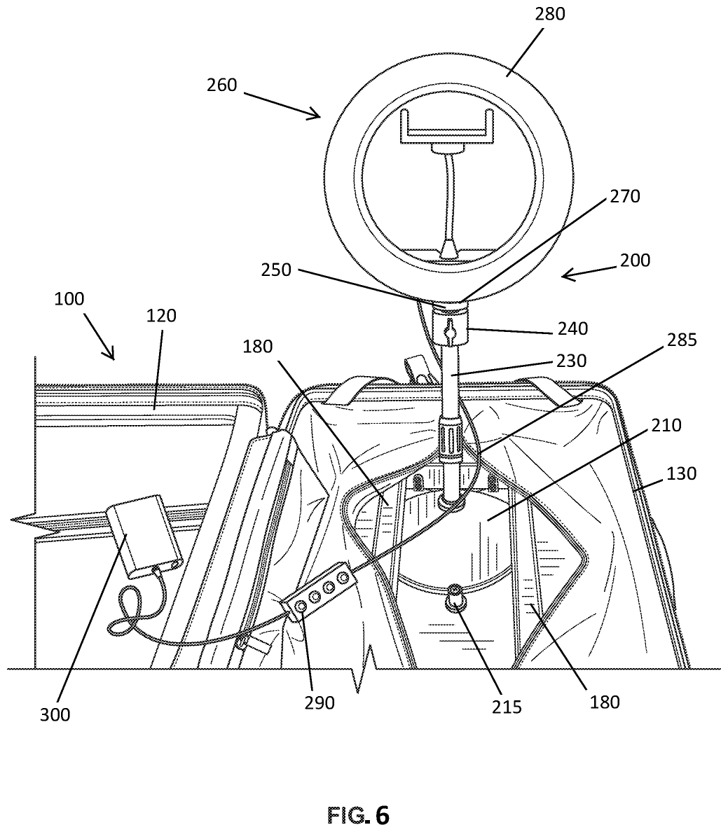

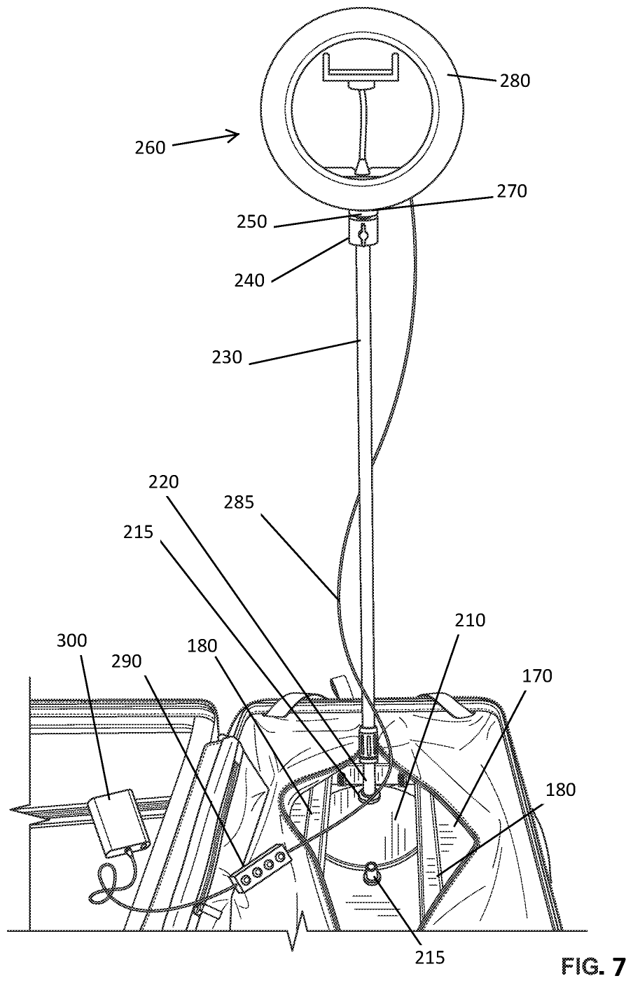

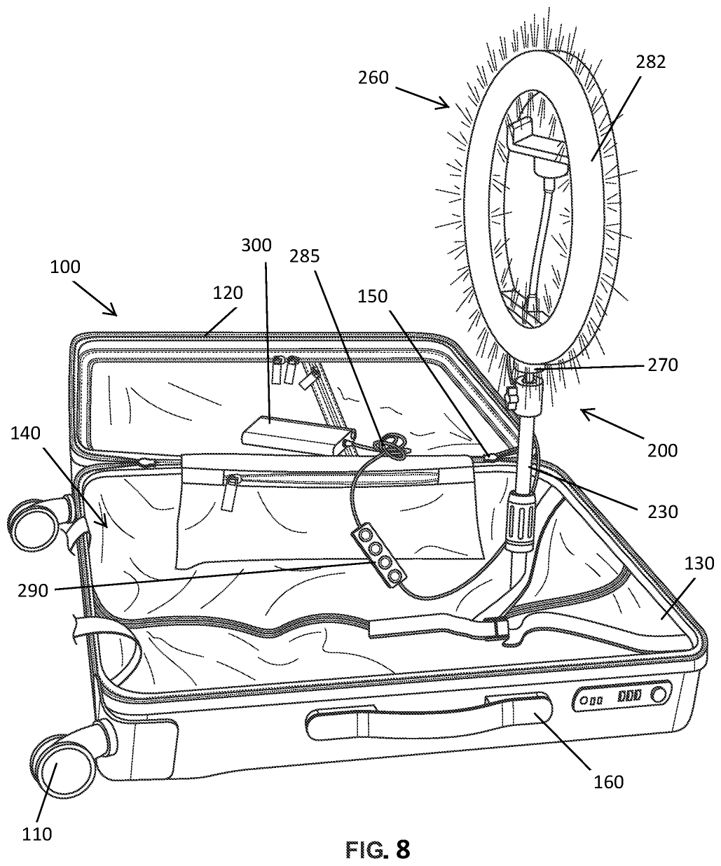

Referring now to FIGS. 1-8 there is provided a traveling case 100 used to transport, store, and as illustrated, act as a movable base for the lighting assembly. The traveling case 100 is illustrated as a suitcase, however, various other cases or bags could be used or employed and the reference to a case 100 actively incorporates such other embodiments. The case 100 includes wheels 110 to allow the case to be easily moved. The wheels 110 while shown and illustrated as a simple pair, could easily include more or less depending on the embodiment.

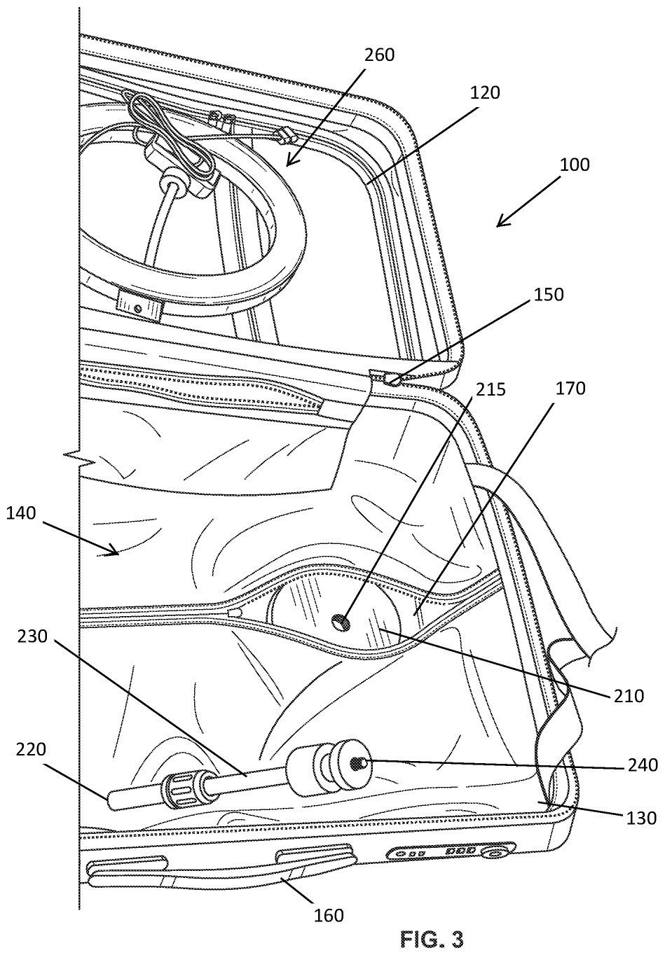

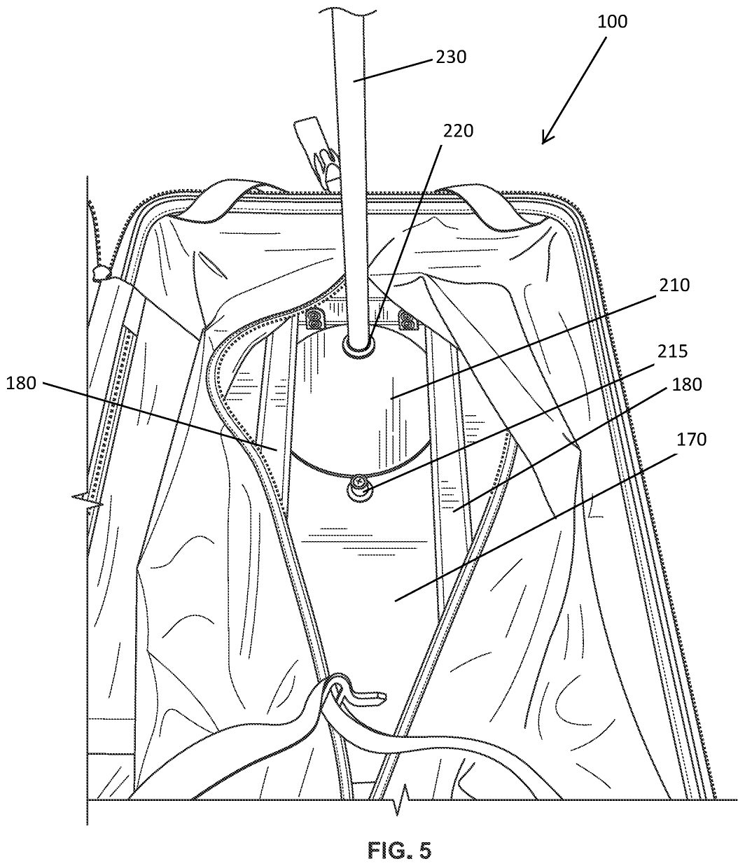

The case 100 is further defined by having a top section 120 and a bottom section 130 to create a cavity 140 therebetween. A sealable fastener 150, such as a zipper, buttons, snaps, etc., is used to close the case 100. The case 100 also includes a handle 160. As can be seen in FIGS. 3 and 5, the case 100 includes a base surface 170. The base surface 170 may also include support ribs 180 running the length of the base surface 170 and typically serve as support for the case 100.

The lighting assembly 200 includes a pedestal 210 mounted to case 100. In one embodiment the pedestal 210 is secured to the base surface 170. The pedestal 210 could be fixed to the base surface or removably secured. In one embodiment a fastener 215 secures the pedestal 210 to the base surface 170. The fastener could include a screw, bolt, glue, hook and loop fastener, etc. In addition, the pedestal 210 could be secured to the case 100 by the support ribs 180. The pedestal 210 includes a threaded aperture 215 to receive a base end 220 of a telescopic support rod 230. The top end of 240 of the rod 230 secures into a receiving end 250 of a lighting device 260. The lighting device 260 further includes a lamp holder 270 wired to supply power to illuminate a lamp 280 and wired 285 to be plugged into a power supply. The wiring 285 could also include a switch box 290 to turn the lamp on and off and/or adjust the lighting intensity. The power supply could simply be a household electrical outlet or as illustrated a portable power supply 300. The portable power supply 300 could be rechargeable as well.

As illustrated through the Figures, the lamp 280 may be a halo lamp 282 such that the entire assembly provides stylists with sufficient portable and adjustable lighting that can be easily assembled for use and disassembled for storage and transport.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

I claim:

1. A portable lighting assembly comprising:
a travel case having a bottom section with a cavity defined within the travel case, the bottom section further defining a base surface; and
a lighting assembly having a pedestal mounted to the bottom section of the travel case, the pedestal includes an aperture; a telescopic support rod having a base end sized to secure to the aperture in the pedestal, and having a top end; a lighting device having a receiving end to secure to the top end of the telescopic support rod, the lighting device further having a lamp holder in connection with a lamp; and a switch assembly wired to the lighting device to allow the lamp to illuminate when connected to a power supply and when activated; and
whereby when dissembled the portable lighting assembly is secured and stored within the travel case and is easily portable; and when assembled, the portable lighting assembly being configured to provide portable lighting when connected to a power supply and when the switch assembly is activated, and wherein the telescopic support rod is configured to adjust the height of the lamp.

2. The portable lighting assembly of claim 1, wherein the power supply is a portable rechargeable power supply configured to connect to the switch assembly.

3. The portable lighting assembly of claim 1, wherein the lamp is a halo lamp.

4. The portable lighting assembly of claim 1, wherein the travel case further includes a top section and a sealable fastener to permit the top section to open and close with respect to the bottom section.

5. The portable lighting assembly of claim 1, wherein the travel case further includes two or more wheels on a base of the travel case.

6. The portable lighting assembly of claim 1, wherein the travel case further includes a handle external to the travel case.

7. The portable lighting assembly of claim 1, wherein the travel case further includes support ribs along a length of the base surface to support the travel case.

8. The portable lighting assembly of claim 7, wherein the pedestal is secured to either the base surface or the support ribs.

9. A portable lighting assembly comprising:
a travel case having a bottom section with a cavity defined within the travel case, the bottom section further defining a base surface, and the travel case further having a top section and a sealable fastener to permit the top section to open and close with respect to the bottom section;
a lighting assembly having a pedestal mounted to the bottom section of the travel case, the pedestal includes an aperture; a telescopic support rod having a base end sized to secure to the aperture in the pedestal, and having a top end; a lighting device having a receiving end to secure to the top end of the telescopic support rod, the lighting device further having a lamp holder in connection with a halo lamp; and a switch assembly wired to the lighting device to allow the lamp to illuminate when connected to a power supply and when activated; and
whereby when dissembled the portable lighting assembly is secured and stored within the travel case and is easily portable; and when assembled, the portable lighting assembly being configured to provide portable lighting when connected to a portable power supply and when the switch assembly is activated, and wherein the telescopic support rod is configured to adjust the height of the lamp.

10. The portable lighting assembly of claim 9, wherein the travel case further includes support ribs along a length of the base surface to support the travel case.

11. The portable lighting assembly of claim 10, wherein the pedestal is secured to either the base surface or the support ribs.

12. The portable lighting assembly of claim 11, wherein the power supply is rechargeable.

13. The portable lighting assembly of claim 12, wherein the travel case further includes two or more wheels on a base of the travel case and further includes a handle external to the travel case.
